(19) United States
(12) Patent Application Publication
(10) Pub. No.: US 2009/0259621 A1
(43) Pub. Date: Oct. 15, 2009

(54) PROVIDING EXPECTED DESIRABILITY INFORMATION PRIOR TO SENDING A RECOMMENDATION

(75) Inventors: Hugh Svendsen, Chapel Hill, NC (US); Sean Purdy, Durham, NC (US)

Correspondence Address: WITHROW & TERRANOVA CT, 100 REGENCY FOREST DRIVE , SUITE 160, CARY, NC, 27518, US

(73) Assignee: CONCERT TECHNOLOGY CORPORATION, Durham, NC (US)

(21) Appl. No.: 12/101,194

(22) Filed: Apr. 11, 2008

(51) Int. Cl. G06F 7/06; G06F 17/30

(52) U.S. Cl. 707/3; 707/E17.014

(57) ABSTRACT

Systems and methods are described for providing information to a recommending user reflecting an expected, or predicted, desirability of a recommendation of a media item for a potential recommendation recipient or a group of potential recommendation recipients. In one embodiment, the recommending user selects a media item to potentially recommend to other users. For each potential recommendation recipient or group of potential recommendation recipients, an expected desirability value reflecting an expected desirability of the media item is determined. The expected desirability values are then presented to the recommending user. Based on the expected desirability values, the recommending user then selects one or more of the potential recommendation recipients or groups of potential recommendation recipients to which to send a recommendation for the media item.

### FIELD OF THE INVENTION

The present invention relates to sending recommendations for media items from a recommending user to one or more recipients.

### BACKGROUND OF THE INVENTION

Systems that allow users to recommend a media item, such as a song, to others users are known. However, in these systems, there is no way for a recommending user to know whether a recommendation for a media item is desirable to another user before the recommending user sends the recommendation. Thus, there is a need for improved recommendation systems and methods.

### SUMMARY OF THE INVENTION

The present invention relates to providing information to a recommending user reflecting an expected, or predicted, desirability of a recommendation of a media item for a potential recommendation recipient or a group of potential recommendation recipients. In one embodiment, the recommending user selects a media item to potentially recommend to other users. For each potential recommendation recipient or group of potential recommendation recipients, an expected desirability value reflecting an expected desirability of the media item is determined. The expected desirability values are then presented to the recommending user. Based on the expected desirability values, the recommending user then selects one or more of the potential recommendation recipients or groups of potential recommendation recipients to which to send a recommendation for the media item. The recommendation for the media item is then sent to the one or more of the potential recommendation recipients or groups of potential recommendation recipients selected by the recommending user.

In one embodiment, the expected desirability values are values determined based on user preferences of the potential recommendation recipients. In addition, the expected desirability values may be a function of play histories of the potential recommendation recipients, demographic information for the potential recommendation recipients, receptiveness of the potential recommendation recipients to recommendations previously made by the recommending user and/or other recommending users, or the like. For the groups of potential recommendation recipients, the expected desirability values may be, for example, an average of the expected desirability values of the potential recommendation recipients within the group or a value determined based on aggregate user preferences of the potential recommendation recipients in the group.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a flow chart illustrating a recommendation process according to one embodiment of the present invention;

FIGS. 2 through 5 illustrate Graphical User Interfaces (GUIs) for presenting expected desirability information to a recommending user according to various embodiments of the present invention;

FIG. 6 illustrates a GUI enabling a recommending user to configure settings related to preventing recommendations from being sent to certain potential recommendation recipients according to one embodiment of the present invention;

FIG. 7 illustrates a recommendation system according to one embodiment of the present invention;

FIG. 8 illustrates the operation of the recommendation system of FIG. 7 according to one embodiment of the present invention;

FIG. 9 is a block diagram of the central system of FIG. 7 according to one embodiment of the present invention; and

FIG. 10 is a block diagram of one of the peer devices of FIG. 7 according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

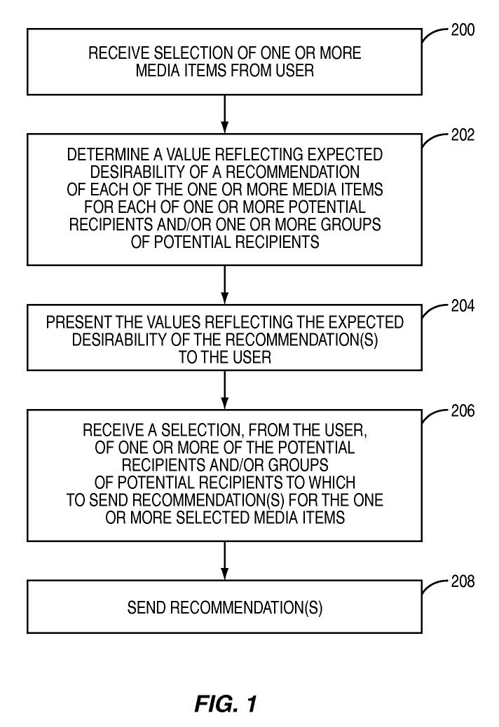

FIG. 1 illustrates a flow chart for a recommendation process in which a recommending user is presented with information reflecting an expected desirability of one or more media items to one or more potential recommendation recipients and/or groups of potential recommendation recipients according to one embodiment of the present invention. First, a selection of one or more media items is received from a user, which is referred to herein as a recommending user (step 200). Next, for each media item selected by the recommending user, a value, i.e. an expected desirability value, reflecting an expected desirability of a recommendation of the media item for each of one or more potential recommendation recipients and/or one or more groups of potential recommendation recipients is determined (step 202). More specifically, in one embodiment, the expected desirability value for a potential recommendation recipient is determined based on metadata describing the media item as compared to user preferences of the potential recommendation recipient.

In addition, the expected desirability values may be a function of a play history of the potential recommendation recipient, demographic information for the potential recommendation recipient, or the like. Still further, the expected desirability values may be a function of receptiveness of the potential recommendation recipient to recommendations previously sent by the recommending user and/or other recommending users. The receptiveness of the potential recommendation recipient may be represented by, for example, a number or percentage of media items previously recommended by the recommending user and/or other recommending users that the potential recommendation recipient has previewed, a number or percentage of media items previously recommended by the recommending user and/or other recommending users that the potential recommendation recipient has purchased, or the like.

As an example, the expected desirability value may be a score, or a function of a score, defined as:

$$Score = {\sum }_{i} ( {W}_{CRITERION , i} \cdot {W}_{ATTRIBUTE , i} ) \cdot 100 ,$$

where W_{CRITERION,i} is a weight assigned to a particular criterion and W_{ATTRIBUTE,i} is a weight assigned to a particular attribute for the criterion for the recommendation of the media item. More specifically, as an example, the media item to potentially be recommended may be a song, and the criterion used to score the song may be genre and decade of release. The user preferences of the potential recommendation recipient may include weights assigned to the genre criterion and the decade of release criterion. Then, for each particular music genre, i.e. an attribute of the genre criterion, the user preferences of the potential recommendation recipient may further include a weight assigned to each of the particular music genres. The weights assigned to the particular music genres may be manually set by the potential recommendation recipient or programmatically assigned to the genres of music based on, for example, songs in a media collection of the potential recommendation recipient, a play history of the potential recommendation recipient, and the like. Likewise, the user preferences of the potential recommendation recipient may include a weight assigned to each of a number of decades of release, i.e. attributes of the decade of release criterion.

Continuing the example above, assume that the user preferences of a potential recommendation recipient are as follows:

| | Weight |
|---|---|
| Scoring Criteria | |
| Genre Category | 9 |
| Decade Category | 7 |

Criteria Attributes

| | |
|---|---|
| Genre Attribute | |
| Alternative | 8 |
| Classic Rock | 5 |
| Arena Rock | 5 |
| Jazz | 5 |
| New Wave | 2 |
| Punk | 4 |
| Dance | 2 |
| Country | 2 |
| Decade Attribute | |
| 1950s | 2 |
| 1960s | 4 |
| 1970s | 7 |
| 1980s | 9 |
| 1990s | 5 |
| 2000s | 5 |

Using these exemplary weights assigned to the scoring criteria and attributes of the scoring criteria, the score for the potential recommendation recipient may be defined as:

Score=(W_{GENRE,CRITERION}·W_{GENRE,ATTRIBUTE}+W_{DECADE,CRITERION}·W_{DECADE,ATTRIBUTE})·100.

Thus, if the media item to potentially be recommended is a song and the metadata for the song indicates that the song is from the classic rock genre and was released in the 1960s, then the score for the potential recommendation recipient is:

$$Score = ( \frac{9}{10} \cdot \frac{5}{10} + \frac{7}{10} \cdot \frac{4}{10} ) \cdot 100 = 73.$$

As for groups of potential recommendation recipients, the expected desirability value of a group of potential recommendation recipients may be, or may be a function of, a composite score for the group of potential recommendation recipients that is provided by combining individual scores determined for the potential recommendation recipients in the group. For example, the score for the group of potential recommendation recipients may be an average of the scores of the potential recommendation recipients in the group. Alternatively, the expected desirability value for a group of potential recommendation recipients may be computed or otherwise determined based on aggregate user preferences, aggregate play histories, aggregate demographic information, or the like of the potential recommendation recipients within the group. For example, using the exemplary user preferences discussed above, the aggregate user preferences may be provided by averaging corresponding criteria weights and attribute weights of the potential recommendation recipients in the group.

For more information regarding an exemplary scoring algorithm, the interested reader is directed to U.S. Patent Application Publication No. 2008/0016205 A1, entitled P2P NETWORK FOR PROVIDING REAL TIME MEDIA RECOMMENDATIONS, which was filed on Jul. 11, 2006 and is hereby incorporated herein by reference in its entirety. Note, however, that any desired scoring algorithm for scoring media items based on user preferences of a user may be used. The scoring algorithms discussed above are exemplary and are not intended to limit the scope of the present invention. Also note that while the scoring algorithm discussed above provides a numerical score, where the expected desirability value is, or is a function of, the numerical score, the present invention is not limited thereto. The expected desirability value may be any type of relative value. For example, the expected desirability value may be a numerical value; a text-based value such as “high,” “medium,” and “low”; a rating such as one star (“*”), two stars (“**”), or three stars (“***”); or the like.

Next, the expected desirability values for the one or more potential recommendation recipients and/or the one or more groups of potential recommendation recipients are presented to the recommending user (step 204). In addition to the expected desirability values, information indicating whether the one or more media items have been played or previewed by the potential recommendation recipients or groups of potential recommendation recipients, information such as whether the one or more selected media items have been recently played or previewed by the potential recommendation recipients or groups of potential recommendation recipients, information indicating whether the one or more selected media items are owned by the potential recommendation recipients or groups of potential recommendation recipients, or the like may be presented to the recommending user. A media item has been recently played or previewed if that media item has been played or previewed within a predetermined amount of time prior to the current time. For groups of potential recommendation recipients, the information indicating whether the one or more selected media items have been recently played or previewed may be a number or percentage of the potential recommendation recipients in the group that have recently played or previewed the one or more media items. Likewise, the information indicating whether the one or more media items are owned by the group of potential recommendation recipients may be a number or percentage of potential recommendation recipients in the group that own the one or more media items. The expected desirability values and, optionally, the additional information assists the recommending user in determining whether the one or more selected media items are likely of interest to the potential recommendation recipients and/or groups of potential recommendation recipients. In other words, the expected desirability values and, optionally, the additional information assists the recommending user in identifying one or more of the potential recommendation recipients and/or groups of potential recommendation recipients, if any, to which to send recommendations for the one or more selected media items.

A selection of one or more of the potential recommendation recipients and/or one or more of the groups of potential recommendation recipients to which to send a recommendation for each of the one or more selected media items is then received from the recommending user (step 206). Then, a recommendation, or recommendations, for the one or more media items selected by the recommending user in step 200 is sent to the one or more potential recommendation recipients and/or groups of potential recommendation recipients selected by the recommending user in step 206 (step 208).

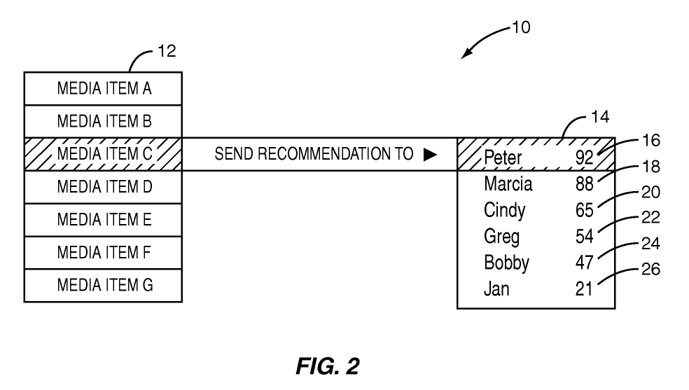

FIGS. 2 through 5 illustrate exemplary Graphical User Interfaces (GUIs) enabling a recommending user to send recommendations as described with respect to FIG. 1 according to one embodiment of the present invention. FIG. 2 illustrates a GUI 10 including a list of media items 12. As an example, the list of media items 12 may be a playlist within a media player application such as, for example, the Apple® iTunes® media player. In this example, the recommending user has selected MEDIA ITEM C as a media item to potentially recommend to one or more potential recommendation recipients. In response, a list of potential recommendation recipients 14 is presented to the recommending user. In one embodiment, potential recommendation recipients in the list of potential recommendation recipients 14 are friends, or buddies, of the recommending user and are identified by a buddy list of the recommending user. In this example, the list of potential recommendation recipients 14 also includes expected desirability values 16 through 26. More specifically, for the potential recommendation recipient Peter, the expected desirability value 16 is computed or otherwise determined based on user preferences of Peter as compared to metadata describing MEDIA ITEM C. Likewise, the expected desirability values 18 through 26 for the other potential recommendation recipients Marcia, Cindy, Greg, Bobby, and Jan, respectively, are computed or otherwise determined based on the metadata for MEDIA ITEM C and the user preferences of those potential recommendation recipients. In this example, the expected desirability values 16 through 26 indicate that MEDIA ITEM C will likely be of interest to Peter and Marcia, less likely to be of interest to Cindy and Greg, and even less likely to be of interest to Bobby and Jan.

The recommending user may then select one of the potential recommendation recipients to which to send a recommendation for MEDIA ITEM C by, for example, clicking on the username of the desired recipient. Alternatively, the recommendation user may be enabled to select multiple recommendation recipients rather than just one from the list of potential recommendation recipients 14.

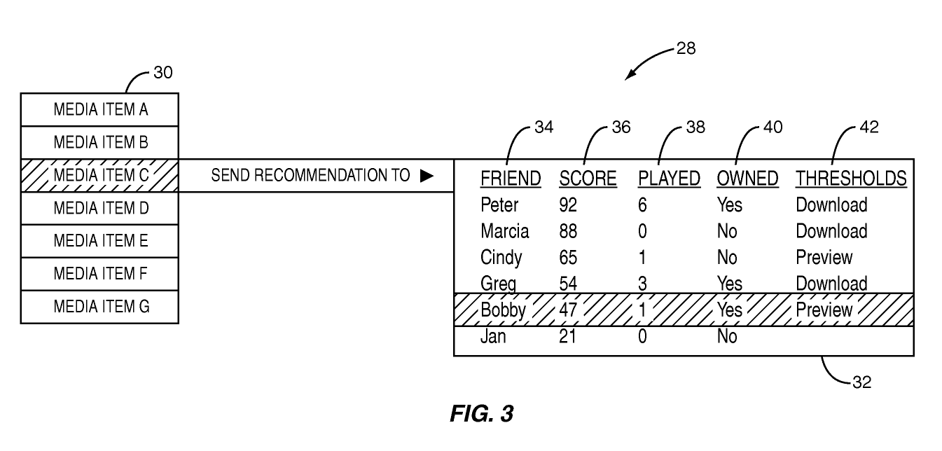

FIG. 3 illustrates a GUI 28 that presents expected desirability values and additional information reflecting the expected desirability of a recommendation for a selected media item for potential recommendation recipients according to another embodiment of the present invention. Again, in this exemplary embodiment, the recommending user selects a media item, MEDIA ITEM C, from a list of media items 30. The list of media items 30 may be, for example, a playlist in a media player application. In response to the selection of MEDIA ITEM C, a list of potential recommendation recipients 32 is presented the recommending user. In this embodiment, the list of potential recommendation recipients 32 includes usernames 34 of the potential recommendation recipients and scores 36, which operate as the expected desirability values for the potential recommendation recipients. In addition, the list of potential recommendation recipients 32 includes playback indicators 38 indicating a number of times that each of the potential recommendation recipients has played or previewed MEDIA ITEM C or recently played or previewed MEDIA ITEM C. Still further, the list of potential recommendation recipients 32 may include owned indicators 40 indicating whether MEDIA ITEM C is owned by, or already in media collections of, the potential recommendation recipients. The additional information provided by the playback indicators 38 and the owned indicators 40 may further assist the recommending user in selecting recipients of a recommendation for MEDIA ITEM C from the list of potential recommendation recipients 32.

In one embodiment, the present invention may be implemented in a recommendation system such as that disclosed in U.S. Patent Application Publication No. 2008/0016205 A1, entitled P2P NETWORK FOR PROVIDING REAL TIME MEDIA RECOMMENDATIONS, which has been incorporated herein by reference in its entirety. In that system, upon receiving a recommendation, a peer device scores the recommended media item based on user preferences of the associated user. Then, if the score is above a first threshold, the peer device automatically downloads and, if necessary, purchases the recommended media item from a remote source such as, for example, a media distribution service. If the score is less than the first threshold and, optionally, greater than a second lower threshold, the peer device may automatically obtain a preview of the recommended media item from a remote source such as, for example, a media distribution service.

Accordingly, in one embodiment, the list of potential recommendation recipients 32 may also include threshold indicators 42 indicating whether the peer devices of the potential recommendation recipients will automatically download or purchase MEDIA ITEM C or automatically obtain a preview of MEDIA ITEM C in response to receiving a recommendation for MEDIA ITEM C. This information may further assist the recommending user in selecting one or more recipients of a recommendation for MEDIA ITEM C from the list of potential recommendation recipients 32.

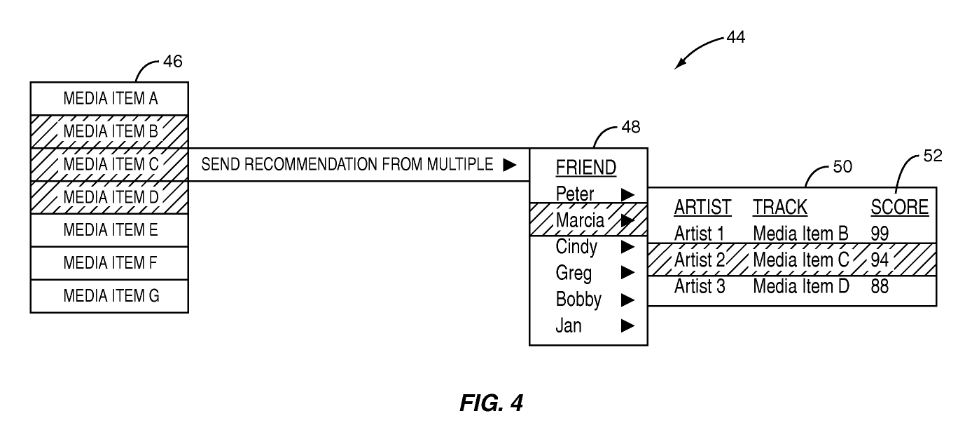

FIG. 4 illustrates a GUI 44 wherein the recommending user has selected multiple media items to potentially recommend to one or more potential recommendation recipients according to another embodiment of the present invention. As illustrated, the GUI 44 includes a list of media items 46. Again, the list of media items 46 may be, for example, a playlist in a media player application. However, the present invention is not limited thereto. Upon selecting MEDIA ITEM B, MEDIA ITEM C, and MEDIA ITEM D, a list of potential recommendation recipients 48 is presented to the recommending user. The recommending user then selects one of the potential recommendation recipients, which in this example is Marcia. As a result, the GUI 44 presents an expected desirability list 50 to the recommending user. The expected desirability list 50 includes information reflecting the expected desirability of recommendations for MEDIA ITEM B, MEDIA ITEM C, and MEDIA ITEM D for Marcia based on metadata describing those media items and user preferences of Marcia. In this example, the expected desirability list 50 includes scores 52 for each of the selected media items MEDIA ITEM B, MEDIA ITEM C, and MEDIA ITEM D, where the scores 52 operate as the expected desirability values for recommendations of those media items for Marcia. The recommending user may then select MEDIA ITEM B, MEDIA ITEM C, or MEDIA ITEM D from the expected desirability list 50 in order to trigger sending of a recommendation for the selected media item to Marcia. Alternatively, the recommending user may be enabled to select more than one of the media items from the expected desirability list 50 to trigger sending of recommendations for those media items to Marcia.

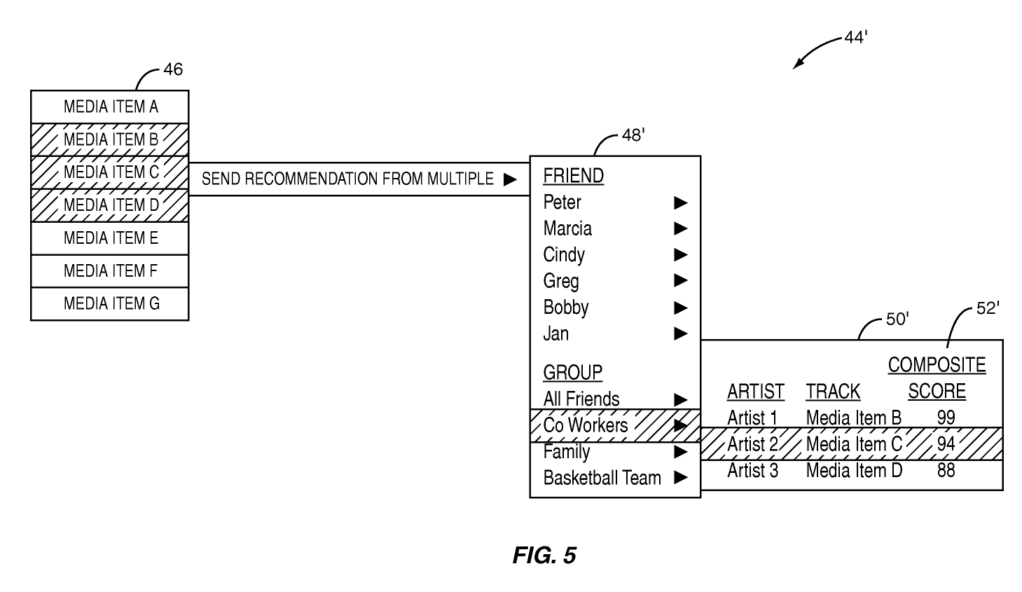

FIG. 5 illustrates a GUI 44′ which is substantially the same as that shown in FIG. 4. However, in this embodiment, the GUI 44′ enables the recommending user to select a group of potential recommendation recipients from a list of potential recommendation recipients 48′. Note that the groups of potential recommendation recipients may be, for example, a co-workers group, a family group, a basketball group, or an “all” group including all of the recommending user's friends or buddies. The groups of potential recommendation recipients may be defined by a buddy list of the recommending user. In this example, the recommending user has selected the co-workers group. As a result, an expected desirability list 50′ is presented to the recommending user, where the expected desirability list 50′ includes information reflecting the expected desirability of recommendations for MEDIA ITEM B, MEDIA ITEM C, and MEDIA ITEM D for potential recommendation recipients in the co-workers group. In this example, the expected desirability list 50′ includes composite scores 52′ for the media items MEDIA ITEM B, MEDIA ITEM C, and MEDIA ITEM D, which operate as the expected desirability values. As discussed above, the composite scores 52′ may be generated by, for example, averaging individual scores of the potential recommendation recipients in the group, aggregating the user preferences of the potential recommendation recipients in the group to provide aggregate user preferences for use in generating the composite score 52′, or the like.

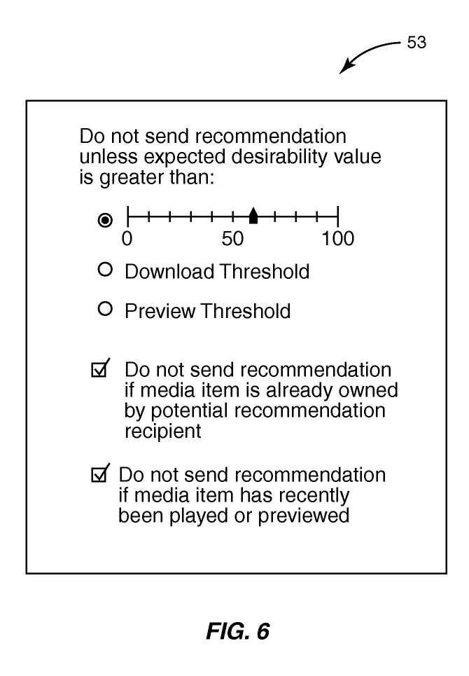

FIG. 6 illustrates an exemplary GUI 53 enabling the recommending user to configure settings defining situations in which recommendations will not be sent to potential recommendation recipients. In this example, a recommendation for a media item will not be sent to a potential recommendation recipient if the expected desirability value is less than a threshold. This threshold may be a user defined threshold, a download threshold, or a preview threshold. In this example, the recommending user has selected to prevent sending of a recommendation to a potential recommendation recipient if the expected desirability threshold is less than 60. In addition, the recommending user has selected to prevent sending of a recommendation to a potential recommendation recipient if the potential recommendation recipient already owns or has otherwise acquired the media item or if the potential recommendation has been recently played or previewed by the potential recommendation recipient.

Note that if the settings above prevent a recommendation to be sent to a potential recommendation recipient, that potential recommendation recipient may be “grayed-out” or not shown in the GUI 10 (FIG. 2), the GUI 28 (FIG. 3), the GUI 44 (FIG. 4), or the GUI 44′ (FIG. 5). As for a group of potential recommendation recipients, when the recommending user has selected a group of potential recommendation recipients to which to send a recommendation, the recommendation will not be sent to those potential recommendation recipients in the group that satisfy the criteria defined in the GUI 53. Thus, in this example, the recommendation will not be sent to those potential recommendation recipients in the group whose expected desirability values do not satisfy the selected threshold, already own or have already acquired the media item, or have recently played or previewed the media item.

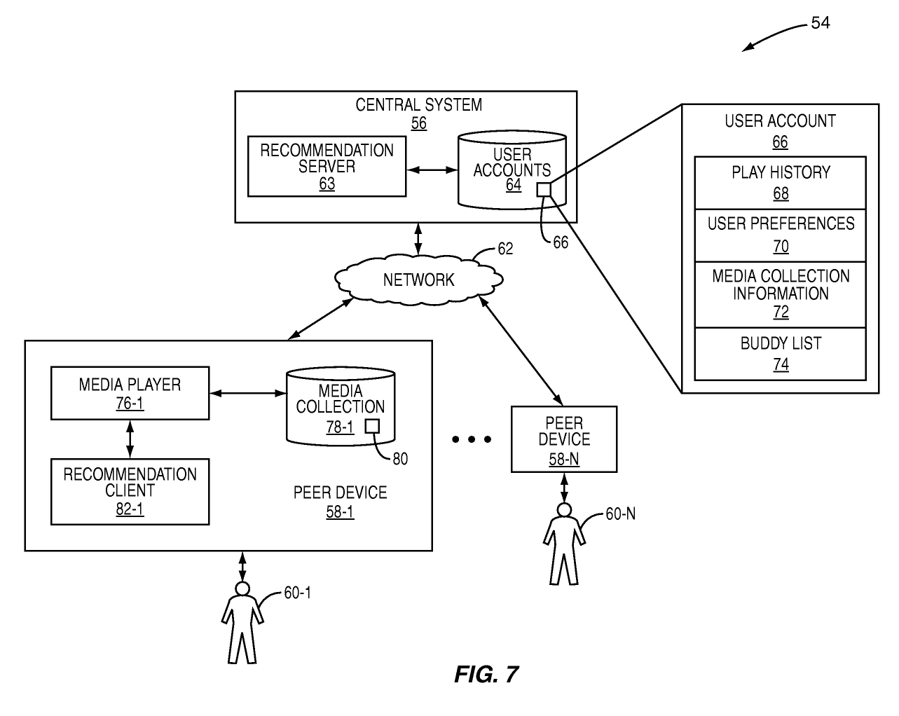

FIG. 7 illustrates a recommendation system 54 according to one embodiment of the present invention. In general, the recommendation system 54 includes a central system 56 and a number of peer devices 58-1 through 58-N having associated users 60-1 through 60-N. The central system 56 and the peer devices 58-1 through 58-N are communicatively coupled via a network 62. The network 62 may be a Wide Area Network (WAN), a Local Area Network (LAN), or a combination thereof and may include wired components, wireless components, or both wired and wireless components. For example, the network 62 may be the Internet.

The central system 56 may be implemented as one or more physical servers. In general, the central system 56 includes a recommendation server 63 and user accounts 64. The recommendation server 63 may be implemented in software, hardware, or a combination thereof. The user accounts 64 may include a user account 66 for each of the users 60-1 through 60-N. Each user account 66 includes a play history 68 of the corresponding user, user preferences 70 of the corresponding user, media collection information 72 identifying media items in a media collection of the corresponding user, and optionally a buddy list 74 of the corresponding user. The play history 68 may include, for example, information identifying each media item played or previewed by the corresponding user. In addition, the play history 68 may include a time stamp for each of the played media items indicating a time and/or date on which the media items were played or previewed. The play histories 68 of the users 60-1 through 60-N may be provided by the peer devices 58-1 through 58-N. For example, as media items are played at the peer device 58-1, the peer device 58-1 may send identifiers of those media items and timestamps to the central system 56 for storage in the user account 66 of the user 60-1.

The user preferences 70 generally include information defining likes and/or dislikes of the corresponding user. For example, the user preferences 70 of the user 60-1 enable the peer devices 58-2 through 58-N of the other users 60-2 through 60-N to determine an expected desirability of media items to the user 60-1 prior to recommending the media items for the user 60-1. For example, the user preferences 70 of a user may include weights or priorities assigned to each of a number of scoring criteria such as music genre, decade of release, artist, album, beats-per-minute, recommending user, video genre, actor or actress, or the like. In addition, the user preferences 70 may include, for each of the scoring criteria, weights assigned to each of a number of attributes or potential values for that scoring criteria. For example, if music genre is a scoring criterion, then each of a number of music genres such as Country, Rock, Classic Rock, Alternative, and the like may each be assigned a weight or priority. The user preferences 70 may be manually defined by the users 60-1 through 60-N or programmatically defined based on the play histories 68 of the users 60-1 through 60-N, the media collection information of the users 60-1 through 60-N, or the like.

The media collection information 72 may include, for example, a Globally Unique Identifier (GUID) for each media item in the media collection of the corresponding user. In addition or alternatively, the media collection information 72 may include metadata describing the media items. For example, for a song, the metadata describing the song may include a title of the song, an artist of the song, an album on which the song was released, a date or decade of release, beats-per-minute, lyrics, or the like. The media collection information 72 may be obtained in any desired manner. For example, the peer devices 58-1 through 58-N may upload the media collection information 72 to the central system 56. However, the present invention is not limited thereto.

The buddy list 74 includes information identifying friends or buddies of the corresponding user. The buddy list 74 may be created for use in the recommendation system 54. In addition or alternatively, the buddy list 74 may be created or populated using buddy lists or contact lists of one or more social networking applications of the users 60-1 through 60-N such as, for example, buddy lists of instant messaging applications, email contact lists, contact lists or buddy lists of online social networking websites such as Facebook or MySpace, or the like. Note that buddy lists 74 of the users 60-1 through 60-N may additionally or alternatively be stored at the corresponding peer devices 58-1 through 58-N.

The peer devices 58-1 through 58-N are generally user devices having network capabilities. For example, each of the peer devices 58-1 through 58-N may be a personal computer, a portable media player such as an Apple® iPod® having WiFi capabilities, a mobile telephone such as an Apple® iPhone, a set-top box, or the like. As illustrated, the peer device 58-1 includes a media player function 76-1, a media collection 78-1 including a number of media items 80, and a recommendation client 82-1. While not illustrated for clarity, the other peer devices 58-2 through 58-N likewise include media player functions 76-2 through 76-N, media collections 78-2 through 78-N, and recommendation clients 82-2 through 82-N.

The media player function 76-1 may be implemented in software, hardware, or a combination thereof and operates to provide playback of media items in the media collection 78-1. The media collection 78-1 includes the media items 80, which may be songs, audio books, podcasts, movies, television programs, video clips, or the like. The recommendation client 82-1 generally operates to send recommendations and receive recommendations as discussed below.

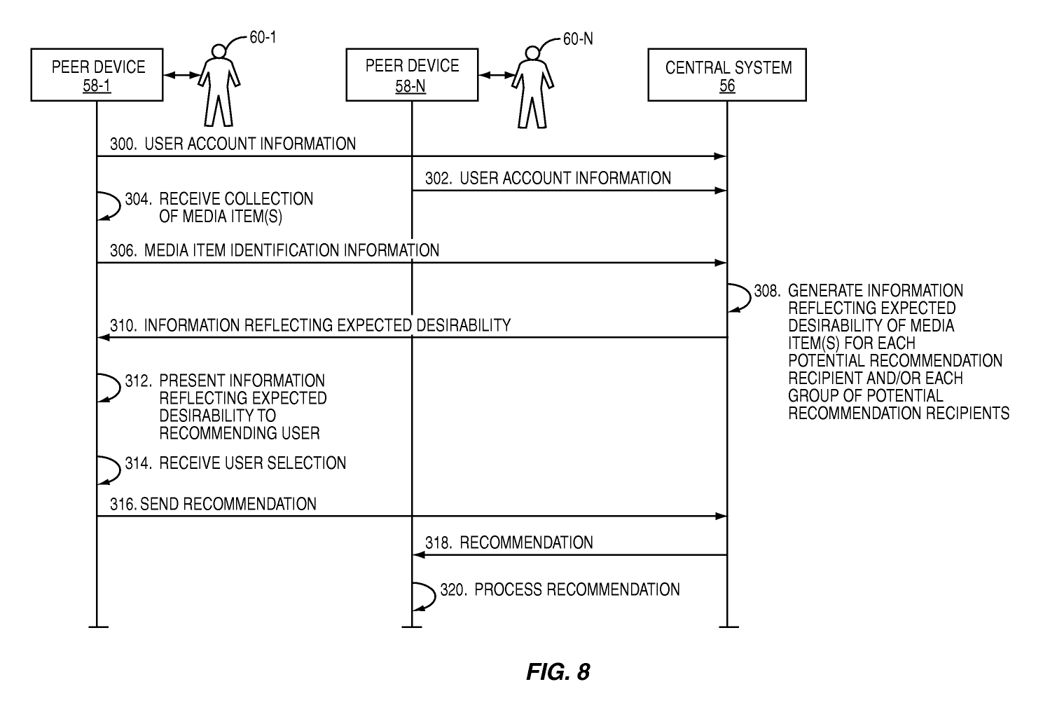

FIG. 8 illustrates the operation of the recommendation system 54 of FIG. 7 according to one embodiment of the present invention. In this example, peer devices 58-1 and 58-N provide user account information to the central system 56 (steps 300 and 302). The user account information may include the play histories 68 of the users 60-1 and 60-N, the user preferences 70 of the users 60-1 and 60-N, the media collection information 72 for the users 60-1 and 60-N, and the buddy lists 74 of the users 60-1 and 60-N. Note that the user account information may be updated as desired. For example, the play histories 68 of the users 60-1 and 60-N may be updated each time playback of a media item occurs at the peer devices 58-1 and 58-N, periodically, or the like.

Next, the peer device 58-1 receives input from the user 60-1 selecting one or more media items to potentially recommend (step 304). In response, the peer device 58-1, and more specifically the recommendation client 82-1, sends information identifying the one or more media items selected by the user 60-1 to the central system 56 (step 306). The information identifying the one or more media items selected by the user 60-1 may be, for example, GUIDs of the media items, titles of the media items, or the like.

The central system 56, and more specifically the recommendation server 63, then generates information reflecting an expected desirability of the one or more media items selected by the user 60-1 for each of a number of potential recommendation recipients and/or groups of potential recommendation recipients (step 308). In this embodiment, the potential recommendation recipients and/or groups of potential recommendation recipients are other users and/or groups of users from the users 60-2 through 60-N identified in the buddy list 74 of the user 60-1. More specifically, for each of the one or more media items, the recommendation server 63 generates an expected desirability value for each potential recommendation recipient based on metadata describing the media item and the user preferences 70 of the potential recommendation recipient. In this example, the user 60-N is a potential recommendation recipient and, as such, an expected desirability value is generated for each of the one or more media items based on the user preferences 70 of the user 60-N. As for groups of potential recommendation recipients, expected desirability values may be generated by combining individual expected desirability values of the potential recommendation recipients in the group or based on aggregate user preferences of the potential recommendation recipients in the group.

As discussed above, in addition to the expected desirability values, the expected desirability information may include, for example, information indicating whether the potential recommendation recipients have played or previewed the media items recently, already own the media items, or will automatically download or preview the media items. In addition, with respect to groups of potential recommendation recipients, the expected desirability information may include information indicating a percentage or number of potential recommendation recipients in a group that have played or previewed the media items recently, already own the media items, or will automatically download or preview the media items.

The expected desirability information is then returned to the peer device 58-1 (step 310). The peer device 58-1, and more specifically the recommendation client 82-1, then presents the expected desirability information to the user 60-1 to assist the user 60-1 in selecting recipients of a recommendation or recommendations for the one or more media items selected in step 304 (step 312). The peer device 58-1, and more specifically the recommendation client 82-1, then receives input from the user 60-1 selecting one or more of the potential recommendation recipients and/or one or more of the groups of potential recommendation recipients to which to send a recommendation, or recommendations, for the one or more media items (step 314). In this example, the user 60-1 has selected to send a recommendation for one of the media items to the user 60-N. As such, the recommendation client 82-1 generates and sends a recommendation for the media item to the central system 56 (step 316). The central system 56, and more specifically the recommendation server 63, then sends the recommendation to the peer device 58-N of the user 60-N (step 318). Alternatively, the recommendation may be directly provided to the peer device 58-N of the user 60-N.

At this point, the recommendation is processed at the peer device 58-N (step 320). For example, the recommendation may be processed in a manner similar to that described in U.S. Patent Application Publication No. 2008/0016205 A1, where recommended media items and media items from the media collection 78-N of the user 60-N are scored and a next media item to play is programmatically selected from the recommended media items and the media items in the media collection 78-N of the user 60-N based on the scores. However, the present invention is not limited thereto. As another example, the peer device 58-N, and more specifically the recommendation client 82-N, may notify the user 60-N of the recommended media item and enable the user 60-N to initiate playback of the recommended media item is desired. Prior to playback, the recommended media item may be downloaded and optionally purchased from a remote media distribution service.

Note that while in the embodiment of FIG. 8 the central system 56 generates the expected desirability information, the present invention is not limited thereto. In an alternative embodiment, the peer device 58-1 may obtain the user preferences 70 of the potential recommendation recipients from the central system 56 in advance or as needed. The peer device 58-1 may then compute or otherwise determine expected desirability values for the potential recommendation recipients and/or groups of potential recommendation recipients based on the user preferences 70.

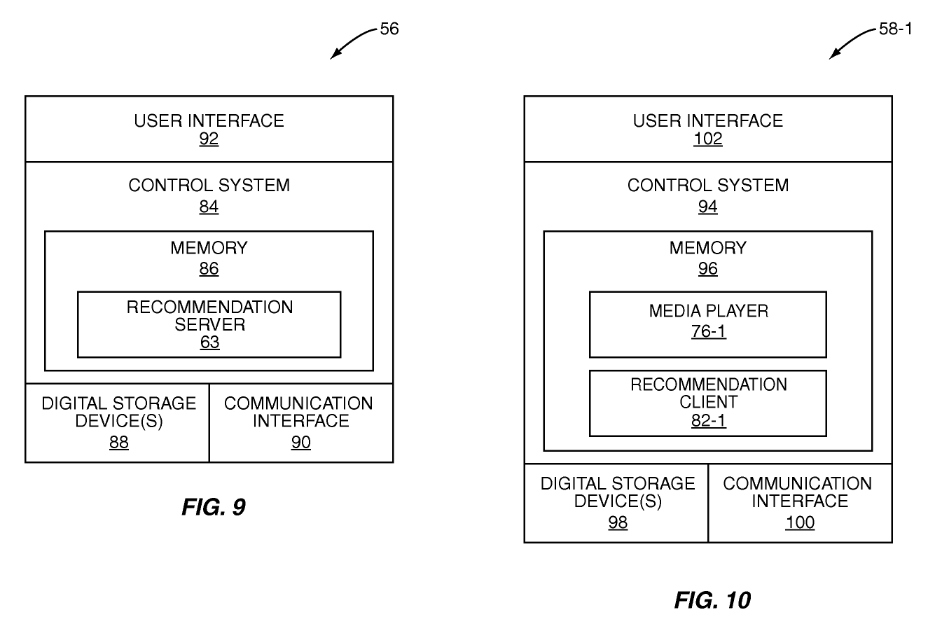

FIG. 9 is a block diagram of the central system 56 of FIG. 7 according to one embodiment of the present invention. In general, the central system 56 includes a control system 84 having associated memory 86. In this embodiment, the recommendation server 63 is implemented in software and stored in the memory 86. However, the present invention is not limited thereto. The recommendation server 63 may be implemented in software, hardware, or a combination thereof. The central system 56 may also include one or more digital storage devices 88 such as, for example, one or more hard disk drives. The one or more digital storage devices 88 may be used to store the user accounts 64 (FIG. 7). The central system 56 also includes a communication interface 90 communicatively coupling the central system 56 to the network 62 (FIG. 7). Lastly, the central system 56 may include a user interface 92, which may include components such as a display, one or more user input devices, or the like.

FIG. 10 is a block diagram of the peer device 58-1 of FIG. 7 according to one embodiment of the present invention. This discussion is equally applicable to the other peer devices 58-2 through 58-N. In general, the peer device 58-1 includes a control system 94 having associated memory 96. In this embodiment, the media player function 76-1 and the recommendation client 82-1 are implemented in software and stored in the memory 96. However, the present invention is not limited thereto. The media player function 76-1 and the recommendation client 82-1 may each be implemented in software, hardware, or a combination thereof. The peer device 58-1 may also include one or more digital storage devices 98 such as, for example, one or more hard disk drives, one or more removable memory cards, or the like. The one or more digital storage devices 98 may be used to store the media collection 78-1 (FIG. 7). Alternatively, all or a portion of the media collection 78-1 may be stored in the memory 96. The peer device 58-1 includes a communication interface 100 communicatively coupling the peer device 58-1 to the network 62 (FIG. 7). Lastly, the peer device 58-1 includes a user interface 102, which may include components such as a display, one or more user input devices, a speaker, or the like.

The recommendation system 54 of FIGS. 7 through 10 is exemplary and not intended to limit the scope of the present invention. For example, in an alternative embodiment, the functionality of the central system 56 may be distributed among the peer devices 58-1 through 58-N. For example, the peer devices 58-1 through 58-N may maintain the play histories 68, the user preferences 70, the media collection information 72, and the buddy lists 74 of the users 60-1 through 60-N using any desired peer-to-peer (P2P) data storage technique. Thus, for example, the peer device 58-1 may obtain the user preferences 70 and optionally additional user account information for potential recommendation recipients from the P2P network formed by the peer devices 58-1 through 58-N in advance or as needed. Based on the account information, the peer devices 58-1 through 58-N may compute or otherwise determine the expected desirability information including the expected desirability scores for potential recommendation recipients as needed.

In addition, while the recommendation clients 82-1 through 82-N are hosted by the peer devices 58-1 through 58-N in the recommendation system 54 of FIGS. 7 through 10, the present invention is not limited thereto. For example, the central system 56 may host an online ecommerce service enabling users to purchase media content such as songs, albums, movies, or the like. The user 60-1 may log into the ecommerce service via, for example, a web browser on the peer device 58-1. The recommendation server 62 may then be part of, or associated with, the ecommerce service such that the user 60-1 can select one or more media items via the web browser at the peer device 58-1. The recommendation server 63 may then generate the expected desirability information for one or more potential recommendation recipients and/or one or more groups of potential recommendation recipients. The user 60-1 may then select one or more of the potential recommendation recipients and/or one or more of the groups of potential recommendation recipients to which to send a recommendation or recommendations for the one or more media items. In response, the recommendation server 63 sends the recommendation or recommendations to the selected recipients or groups of recipients. The recommendations may be sent to the recipients via email, text-messaging, or the like. Alternatively, if the recipients have an account with the ecommerce service, the recommendation or recommendations may be provided to the recipients the next time that they log into the ecommerce service.

Those skilled in the art will recognize improvements and modifications to the preferred embodiments of the present invention. All such improvements and modifications are considered within the scope of the concepts disclosed herein and the claims that follow.

What is claimed is:

1. A method comprising:
receiving user input selecting a media item from a recommending user;
obtaining expected desirability information for the media item for each potential recommendation recipient of one or more potential recommendation recipients; and
presenting the expected desirability information to the recommending user.

2. The method of claim 1 further comprising:
receiving user input, from the recommending user, selecting at least one recipient of a recommendation for the media item from the one or more potential recommendation recipients; and
causing the recommendation for the media item to be provided to the at least one recipient.

3. The method of claim 1 wherein, for each potential recommendation recipient of the one or more potential recommendation recipients, the expected desirability information comprises an expected desirability value for the media item determined based on metadata describing the media item and user preferences of the potential recommendation recipient.

4. The method of claim 3 wherein the expected desirability value is further determined based on at least one of a group consisting of: information indicating whether each potential recommendation recipient owns the media item, information indicating whether each potential recommendation recipient has played the media item, information indicating whether each potential recommendation recipient has previewed the media item, information indicating whether each potential recommendation recipient has recently played the media item, and information indicating whether each potential recommendation recipient has recently previewed the media item.

5. The method of claim 3 wherein, for each potential recommendation recipient of the one or more potential recommendation recipients, the expected desirability value is indicative of whether a recommendation for the media item is expected to be desirable to the potential recommendation recipient.

6. The method of claim 3 wherein obtaining the expected desirability information comprises:
obtaining the user preferences of each potential recommendation recipient of the one or more potential recommendation recipients; and
for each potential recommendation recipient of the one or more potential recommendation recipients, determining the expected desirability value based on the metadata describing the media item and the user preferences of the potential recommendation recipient.

7. The method of claim 6 wherein obtaining the user preferences comprises obtaining the user preferences of each potential recommendation recipient of the one or more potential recommendation recipients from at least one remote system.

8. The method of claim 7 wherein the at least one remote system is a central system operating to store user preferences for a plurality of users comprising the one or more potential recommendation recipients.

9. The method of claim 3 wherein obtaining the expected desirability information comprises obtaining the expected desirability value for the media item for each potential recommendation recipient of the one or more potential recommendation recipients from a central system.

10. The method of claim 3 wherein obtaining the expected desirability information comprises:
providing information identifying the media item to a central system, wherein for each potential recommendation recipient of the one or more potential recommendation recipients the central system determines the expected desirability value based on the metadata describing the media item and the user preferences of the potential recommendation recipient; and
receiving the expected desirability value for each potential recipient from the central system.

11. The method of claim 1 wherein, for each potential recommendation recipient of the one or more potential recommendation recipients, the expected desirability information comprises an expected desirability value for the media item determined based on at least one of a group consisting of: information indicating whether each potential recommendation recipient owns the media item, information indicating whether each potential recommendation recipient has played the media item, information indicating whether each potential recommendation recipient has previewed the media item, information indicating whether each potential recommendation recipient has recently played the media item, and information indicating whether each potential recommendation recipient has recently previewed the media item.

12. The method of claim 1 wherein, for each potential recommendation recipient of the one or more potential recommendation recipients, the expected desirability information further comprises information indicating whether the media item is already part of a media collection of the potential recommendation recipient.

13. The method of claim 1 wherein, for each potential recommendation recipient of the one or more potential recommendation recipients, the expected desirability information further comprises information indicating whether the media item has been played by the potential recommendation recipient.

14. The method of claim 1 wherein, for each potential recommendation recipient of the one or more potential recommendation recipients, the expected desirability information further comprises information indicating whether the media item has been previewed by the potential recommendation recipient.

15. The method of claim 1 wherein, for each potential recommendation recipient of the one or more potential recommendation recipients, the expected desirability information further comprises information indicating whether the media item has recently been played by the potential recommendation recipient.

16. The method of claim 15 wherein the media item has recently been played if the media item has been played within a predefined amount of time prior to a current time.

17. The method of claim 1 wherein, for each potential recommendation recipient of the one or more potential recommendation recipients, the expected desirability information further comprises information indicating whether the media item has recently been previewed by the potential recommendation recipient.

18. The method of claim 17 wherein the media item has recently been previewed if the media item has been previewed within a predefined amount of time prior to a current time.

19. The method of claim 1 wherein the one or more potential recommendation recipients comprise other users identified by a buddy list of the recommending user.

20. The method of claim 1 wherein the method is a method of operation for a user device.

21. The method of claim 1 wherein the method is a method of operation for a central system interacting with the recommending user and the one or more potential recommendation recipients via user devices connected to the central system over a network.

22. A user device comprising:
a) a user interface;
b) a communication interface; and
c) a control system, associated with the user interface and the communication interface, and adapted to:
i) receive user input selecting a media item from a recommending user via the user interface;
ii) obtain expected desirability information for the media item for each potential recommendation recipient of one or more potential recommendation recipients; and
iii) present the expected desirability information to the recommending user via the user interface.

23. The user device of claim 22 wherein the control system is further adapted to:
receive user input, from the recommending user via the user interface, selecting at least one recipient of a recommendation for the media item from the one or more potential recommendation recipients; and
cause the recommendation for the media item to be provided to at least one second user device of the at least one recipient.

24. A computer readable medium comprising software for instructing a user device to:
receive user input selecting a media item from a recommending user;
obtain expected desirability information for the media item for each potential recommendation recipient of one or more potential recommendation recipients; and
present the expected desirability information to the recommending user.

25. The computer readable medium of claim 24 further instructing the user device to:
receive user input, from the recommending user, selecting at least one recipient of a recommendation for the media item from the one or more potential recommendation recipients; and
cause the recommendation for the media item to be provided to at least one second user device of the at least one recipient.

26. A method comprising:
receiving user input selecting a media item from a recommending user;
obtaining expected desirability information for the media item for one or more groups of potential recommendation recipients; and
presenting the expected desirability information to the recommending user.

27. The method of claim 26 further comprising:
receiving user input, from the recommending user, selecting at least one group of recipients for a recommendation for the media item from the one or more groups of potential recommendation recipients; and
causing the recommendation for the media item to be provided to each recommendation recipient in the at least one group of recipients.

28. The method of claim 26 wherein, for each group of potential recommendation recipients of the one or more groups of potential recommendation recipients, the expected desirability information comprises a composite expected desirability value for the media item determined based on metadata describing the media item and user preferences of potential recommendation recipients within the group of potential recommendation recipients.

29. The method of claim 28 wherein obtaining the expected desirability information comprises, for each group of potential recommendation recipients:
obtaining the user preferences of each potential recommendation recipient in the group of potential recommendation recipients;
for each potential recommendation recipient in the group of potential recommendation recipients, determining an expected desirability value based on the metadata describing the media item and the user preferences of the potential recommendation recipient; and
combining the expected desirability values of the potential recommendation recipients in the group of potential recommendation recipients to provide the composite expected desirability value for the group of potential recommendation recipients.

30. The method of claim 28 wherein obtaining the expected desirability information comprises, for each group of potential recommendation recipients:
obtaining the user preferences of each potential recommendation recipient in the group of potential recommendation recipients;
aggregating the user preferences of the potential recommendation recipients in the group of potential recommendation recipients to provide aggregate user preferences for the group of potential recommendation recipients; and
determining the composite expected desirability value for the group of potential recommendation recipients based on the metadata describing the media item and the aggregate user preferences for the group of potential recommendation recipients.

31. A user device comprising:
a) a user interface;
b) a communication interface; and
c) a control system, associated with the user interface and the communication interface, and adapted to:
i) receive user input selecting a media item from a recommending user via the user interface;
ii) obtain expected desirability information for the media item for one or more groups of potential recommendation recipients; and
iii) present, via the user interface, the expected desirability information to the recommending user.

32. The user device of claim 31 wherein the control system is further adapted to:
receive user input, from the recommending user via the user interface, selecting at least one group of recipients for a recommendation for the media item from the one or more groups of potential recommendation recipients; and
cause the recommendation for the media item to be provided to a second user device of each of at least one recipient of the at least one group of recipients.

33. A computer readable medium comprising software for instructing a user device to:
receive user input selecting a media item from a recommending user;
obtain expected desirability information for the media item for one or more groups of potential recommendation recipients; and
present the expected desirability information to the recommending user.

34. The computer readable medium of claim 33 further instructing the user device to:
receive user input, from the recommending user, selecting at least one group of recipients for a recommendation for the media item from the one or more groups of potential recommendation recipients; and
cause the recommendation for the media item to be provided to a second user device of each of at least one recipient of the at least one group of recipients.
